(19) United States
(12) Patent Application Publication
(10) Pub. No.: US 2009/0265415 A1
(43) Pub. Date: Oct. 22, 2009

(54) COMPUTERISED SYSTEM AND METHOD FOR OPTIMISING DOMAIN PARKING PAGES

(76) Inventor: David Paul Harry, Dingley Village (AU)

Correspondence Address: WINSTON & STRAWN LLP;PATENT DEPARTMENT, 1700 K STREET, N.W., WASHINGTON, DC, 20006, US

(21) Appl. No.: 12/425,725

(22) Filed: Apr. 17, 2009

Related U.S. Application Data
(60) Provisional application No. 61/045,700, filed on Apr. 17, 2008.

(51) Int. Cl. G06F 15/16

(52) U.S. Cl. 709/202

(57) ABSTRACT

The present invention relates generally to domain parking services, and in particular to the management and optimisation of advertising links presented in a domain parking page by domain parking services.

### CROSS REFERENCE TO RELATED APPLICATIONS

This application claims priority from U.S. Provisional Application No. 61/045,700 filed Apr. 17, 2008, which application is incorporated herein by reference.

### FIELD OF THE INVENTION

The present invention relates generally to domain parking services, and in particular to the management and optimisation of advertising links presented in a domain parking page by domain parking services.

### BACKGROUND OF THE INVENTION

There are currently domain parking services which offer owners of domain names a domain parking page for display while a custom website is in development. A domain parking page may be a simple common generic page with a message indicating that the website is in development. During this development period, a person accessing the domain name is presented with the domain parking page instead of a dead page which would cause the display of an error message. The display of the domain parking page thus allows the person accessing the domain name to anticipate the creation of a custom website.

More recently however, domain parking pages have been used to provide additional information and advertisements in addition to or instead of any generic message about a future site. The information and advertisement displayed on the domain parking page, however, may be irrelevant and of no interest to an accessing person. A need exists to display information and advertisements that are relevant to a person accessing the domain parking page because the more relevant the information and advertisements, the more likely a user will be to interact with the displayed information. In the context of Internet-based advertising, these user interactions translate directly into revenue able to be earned by owners of domain names.

In Internet-based advertising, advertisers typically create accounts with a search engine supplier or the like. The goal of the advertiser is to entice users of the search engine to click on an advertising link through to an advertiser's website. The advertiser pays for a click that leads the user to their own website from the search engine. In order to maximise the effectiveness of the click, the advertiser configures their advertisement such that it will only be displayed when the user performs a search on a search keyword that the advertiser deems is indicative of their target demographic. For example, when a user searches for an advertiser's keyword, they are presented with advertising links to the top ten advertisers as determined by the search engine proprietor.

When an advertiser configures a keyword for use in their advertising campaign, an associated advertisement may also be displayed on domain names other than via the search engine portal. This feature has fuelled a domain name market where investors purchase domain names with the sole intention of displaying sponsors' advertising links. The simplest and most effective means of doing this is to supply the domain name to a parking program.

Parking programs have a revenue sharing agreement with search engine proprietors whereby the search engine proprietor pays the parking program a percentage of the advertising revenue originating from the parked domain names. The parking program in turn pays a portion of the revenue to the owner of the actual domain name. The owner of the domain name intends to earn revenue from parking a domain name at a particular parking program. The only requirement is to set a keyword on that name that is relevant to the domain name itself. Having done that, the domain name will continue to earn money in accordance with the money paid by the advertiser and the number of clicks resulting from web surfer activity.

Domain name owners, otherwise known as “domainers”, are aware that the revenue return for their domain name originates from advertising links displayed for the keyword they have used to drive their campaign. Therefore, the keyword has the ability to affect the cost per advertisement click by changing the advertisements displayed. Domainers will often try several different keywords to determine which yields the best result. However, domainers face the problem that changing keywords and monitoring results is a very time consuming process for only a few different domain names. This problem is greatly magnified for most domainers who tend to own many hundreds or thousands of domain names. Accordingly, domainers quickly reach a point where they either have too many domains to monetise or they prioritise their domain names and leave a large portion unprioritised.

It would therefore be desirable to provide a method and system for optimising the presentation of advertising links on domain parking pages in order to maximise the revenue generating potential of domain name owners.

### SUMMARY OF THE INVENTION

One aspect of the invention provides a computerised system for optimising domain parking pages, the system including:

one or more domain parking servers for populating domain parking pages with advertising links and serving the domain parking pages to users;

a database in communication with each domain parking server for maintaining domain name configuration data associating parked domain names with active keywords, wherein, upon receipt of a parked domain name, each domain parking server uses an associated active keyword to recover one or more advertising links to populate each domain parking page according to relevant domain name configuration data; and

a domain parking interface server, in communication with each domain parking server, for managing the domain name configuration data,

the domain parking interface server including:

an optimisation engine for automatically determining a series of actions to take upon the domain name configuration data in order to optimise user selection of the advertising links.

In one or more embodiments, the optimisation engine acts to:

score keywords in terms of their potential for optimising use selection of the advertising links; and

associate advertising links with keywords based upon those scores.

In one or more embodiments, the optimisation engine acts to score keywords from historically observed user selections of advertising links associated with each keyword.

Another aspect of the invention provides a domain parking interface server forming part of a computerised system for optimising domain parking pages, the system including one or more domain parking servers for populating domain parking pages with advertising links to domain names and serving the domain parking pages to users; and a database in communication with each domain parking server for maintaining domain name configuration data associating parked domain names with active keywords, wherein, upon receipt of a parked domain name, each domain parking server uses an associated active keyword to recover one or more advertising links to populate each domain parking page according to relevant domain name configuration data,

wherein the domain parking interface server, in communication with each domain parking server, acts to manage the domain name configuration data, the domain parking interface server including:

an optimisation engine for automatically determining a series of actions to take upon the domain name configuration data in order to optimise user selection of the advertising links.

Yet another aspect of the invention provides a method for optimising domain parking pages in a computerised system for optimising domain parking pages including one or more domain parking servers for populating domain parking pages with advertising links to domain names and serving the domain parking pages to users; a database in communication with each domain parking server for maintaining domain name configuration data associating parked domain names with active keywords, wherein, upon receipt of a parked domain name, each domain parking server uses an associated active keyword to recover one or more advertising links to populate each domain parking page according to relevant domain name configuration data; and a domain parking interface server, in communication with each domain parking server, for managing the domain name configuration data, the method including the step of:

automatically determining a series of actions to take upon the domain name configuration data in order to optimise user selection of the advertising links.

A still further aspect of the invention provides a computer program for use in a computerised system for optimising domain parking pages, the system including one or more domain parking servers for populating domain parking pages with advertising links to domain names and serving the domain parking pages to users; a database in communication with each domain parking server for maintaining domain name configuration data associating parked domain names with active keywords, wherein, upon receipt of a parked domain name, each domain parking server uses an associated active keyword to recover one or more advertising links to populate each domain parking page according to relevant domain name configuration data; and a domain parking interface server, in communication with each domain parking server, for managing the domain name configuration data, wherein the computer program includes a series of instructions for causing the domain parking interface server to:

automatically determine a series of actions to take upon the domain name configuration data in order to optimise user selection of the advertising links.

These and other features, aspects and advantages of the invention will be more fully understood when considered with respect of the following description, appended claims and accompanying drawings.

### BRIEF DESCRIPTION OF THE DRAWINGS

In the drawings:

FIG. 1 is a schematic diagram of a computerised system for optimising domain parking pages in accordance with one embodiment of the present invention;

FIGS. 2, 4, 5 and 6 are flow charts depicting selected operations performed by various elements of the computerised system shown in FIG. 1; and

FIG. 3 is a graphical depiction of an exemplary domain parking page served by a domain parking server forming part of the computerised system shown in FIG. 1.

### DETAILED DESCRIPTION

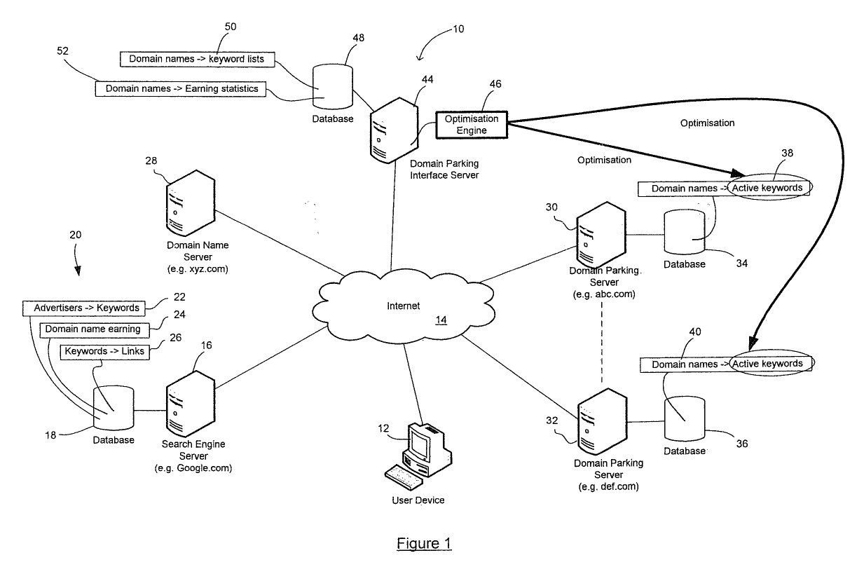

Referring now to FIG. 1, there is shown generally a computerised system 10 for optimising domain parking pages. The computerised system 10 includes a user device 12 connected to a communications network 14, such as the Internet. The user device 12 may be a personal computer equipped with an Internet connection and processor configured with browser software for retrieving and viewing information obtained from the Internet. The user device 12 may also take the form of other wired or wireless devices such as a mobile telephone, personal data assistant and the like.

Also connected to the communications network 14 is a search engine server 16 and associated database 18. The search engine server 16 maintains a website providing a user accessible interface to a search engine. The database 18 maintains domain name configuration data 20 including notably a list 22 of keywords which advertisers have paid to use in relation to Internet-based advertising, a list 24 of advertising links associated with the keywords, and a list 26 of domain name earnings from user activity in relation to clicking an the advertising links. The associations between the keywords and advertising links may be determined by a variety of criteria decided upon by the proprietor of the search engine. In a simple model, the associations may be derived from the payment made by an advertiser for the association of that advertising link with a particular keyword.

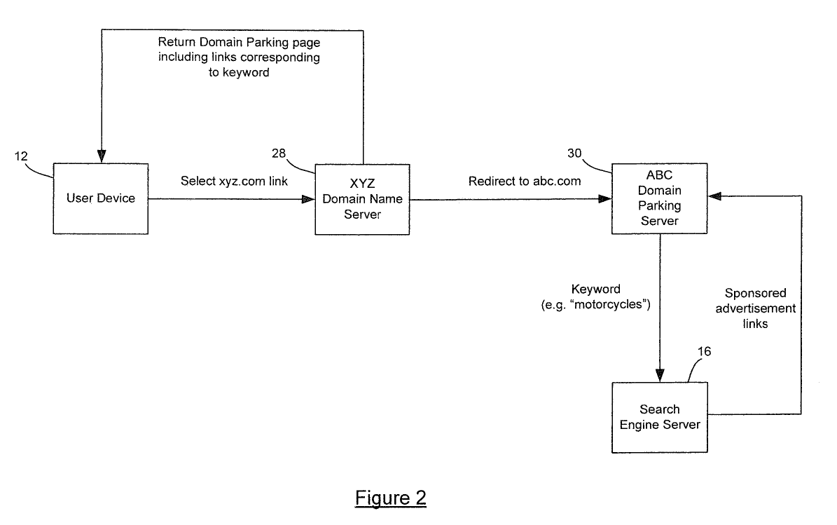

The system 10 further includes a domain name server 28. As shown in FIG. 2, when the browser software on the user device 12 is directed to navigate to a parked domain name on the domain name server 28, the domain name server 28 will direct the uniform resource locator (URL) request from the user device 12 to a domain parking page on a domain parking server 30. For example, a URL request for an HTML page at the parked domain name “xyz.com” may cause a URL request to be transmitted from the domain name server 28 to a domain parking page “abc.com” at the domain parking server 30. The redirection may be done in any conventional manner as long as the domain name included in the original URL request is embedded in a redirected URL to the domain parking server 30. For example, the domain name server 28 may be configured with a redirect service that allows the domain name owner to simply input the redirection URL, and the service automatically redirects all requests for the domain name to the domain parking server 30.

Similar redirection mechanisms may be used to redirect URL requests intended for domain names associated with other domain name servers to a number of other domain parking servers. In FIG. 1, only one additional such additional domain parking server 32 is illustrated.

A database 34 is associated with the domain parking server 30, whilst a further database 36 is associated with the domain parking server 32. The database 34 maintains domain name configuration data 38 including a list of parked domain names, a series of active keywords and associations between the active keywords and parked domain names. Similar domain name configuration data 40 is maintained in the database 36.

Upon receipt of a redirected URL request from the domain name server 28, the domain parking server 30 determines from the domain configuration data 38 one or more active keywords associated with the parked domain name to which the URL request was originally sent. For example, upon receipt of a redirected request to the domain name “Motorcycles.com”, the domain parking server 30 may determine from the domain configuration data 38 that the keyword “ducatti” has been associated with that parked domain name.

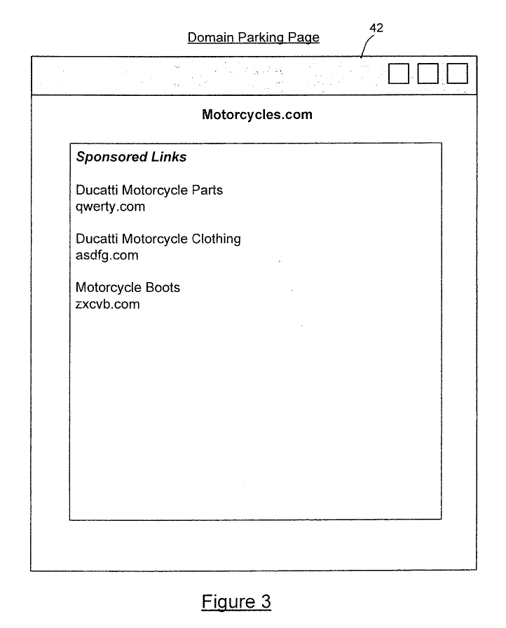

Having thus identified a keyword associated with the parked domain name, the domain parking server 30 transmits the keyword to the search engine server 16 in order to identify one or more advertising links to domain names associated with that keyword from the domain name configuration data 20. The search engine server 16 then supplies the identified advertising links to the domain parking server 30 for insertion into a domain parking page which is then served to the user device 10. One such domain parking page 42, including three exemplary advertising links, is shown in FIG. 3.

A similar process is undertaken by the domain parking server 32 and like domain parking servers to which URL requests may be redirected, in order to select and display advertising links to domain names which are associated with the keyword selectively associated with the parked domain name in the configuration data 40. It will be appreciate that these advertising links are likely to generate corresponding user activity by clicking on the displayed advertising links on the domain parking page 42.

Returning once again to FIG. 1, the system 10 also includes a domain parking interface server 44, including an optimisation engine 46. The domain parking interface server 44 enables the administration of domain name portfolios by individual Account Managers. The optimisation engine 46 may be implemented via one or more processors executing computer program instructions stored in a local memory. The optimisation engine 46 acts to optimise the domain name configurations 38 and 40 maintained respectively on the databases 34 and 36 so as to maximise the potential revenue earned by advertisers.

A database 48 is associated with the domain parking interface server 44. The database 48 maintains a list 50 of keywords and domain names registered by domainers managing their parked domain name portfolio via the management and optimisation service provided by the domain parking interface server 44. The active keywords associated with parked domain names in each domain parking service are selected from the lists 50 maintained by the database 48. The database 48 also maintains a list 52 of revenue earned from parked domain names managed and optimised via the management and optimisation service. This information is provided by the search engine server 16.

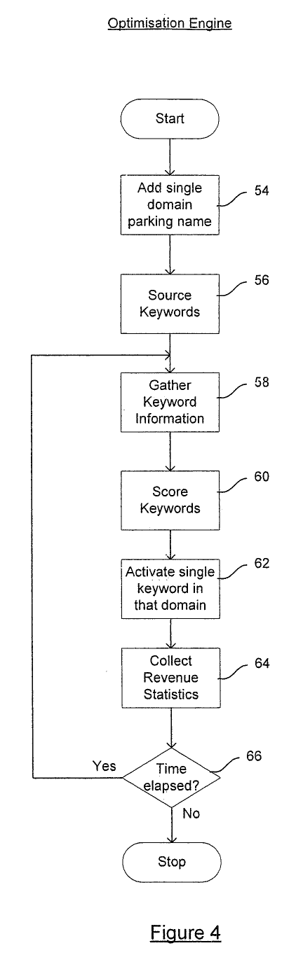

The basic strategy for carrying out this administration function is shown in FIG. 4 and includes the steps. At step 54, adding a single domain parking name to the domain parking interface server in order to add to the domain name portfolio to be administered for a particular domainer. At step 56, a list of keywords pertaining to the domain name are sourced. At step 58, information is gathered about the keywords. At step 60, the keywords are scored in terms of the revenue earning potential. At step 62, a single keyword is activated for a particular domain name. At step 64, revenue statistics are collected from the domain name. After a fixed period of time, as determined at step 66, which may be for example 24 hours, step 58 to 64 are repeated.

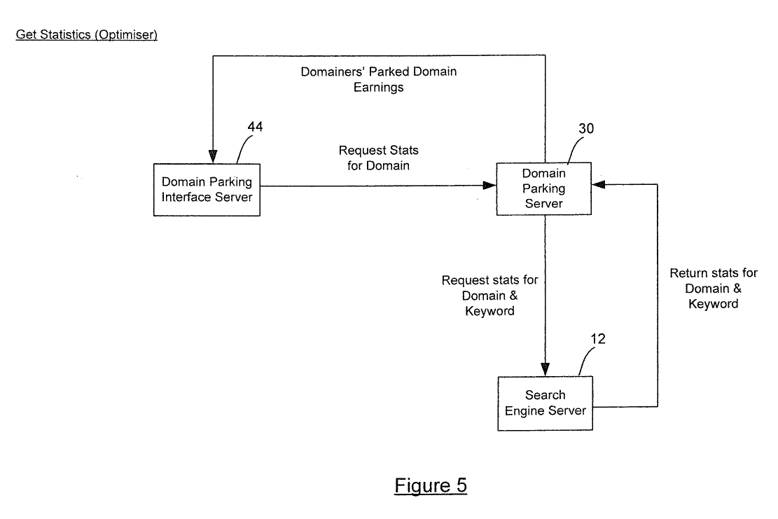

As can be seen in FIG. 5, in order to gather revenue statistics, the domain parking interface server 44 forwards a request to the domain parking servers 30 and 32. The domain parking servers 30 and 32 then each request that the search engine server 12 provide revenue statistics for their parked domain names and associated active keywords. Once received from the search engine server 12, the domainers' parked domain earnings are transmitted to the domain parking interface server 44.

Accordingly, new users or domainers of the domain parking interface server 44 are initially required to provide access to their account details at the domain parking services to which they are subscribed. By providing this access information, the domain parking interface server 44 is able to connect to the various domain parking programs via an application programming interface (API). The API enables the optimisation engine to obtain details of the domainer's domain portfolio and to import revenue earning history of those domain names.

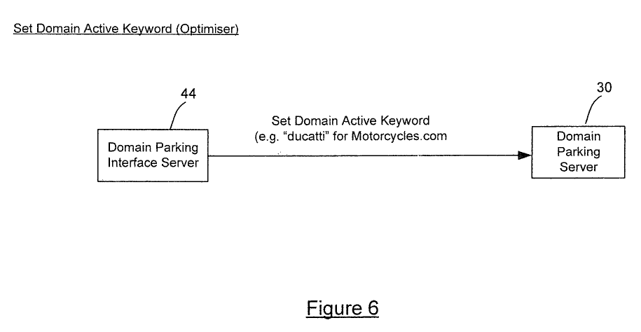

Once the domain details have been set up, the domain parking interface server 44 will only have one keyword recorded against each domain name. That is, the keyword that the domainer has set up themselves, as shown in FIG. 6. Since the purpose of the optimisation engine 46 is to activate the best keyword revenue earning potential, it requires that there be multiple keywords configured for each domain name.

The domain parking interface server 44 can employ any one of a number of methods for obtaining a longer list of keywords. These methods may include the following:

(a) the domain parking interface server 44 can use the domainer's original source keywords to determine a list of similar keywords;

(b) the domain parking interface server 44 can associate other domains in its database and can use keywords configured against those domain names as inputs for this new domain name;

(c) the domain parking interface server 44 can attempt to identify that the domain name belongs to a generalised and/or specialised category of domain names and attempt to find keywords configured to other names within that category;

(d) the domain parking interface server 44 can apply dictionary semantics to either the domain name, the initial keyword or both to derive dictionary based sources of new keywords;

(e) the domain parking interface server 44 can attempt to identify that the domain name has many web visitors deriving from a similar yet very popular site on the Internet and use this information to derive additional keywords;

(f) the domain parking interface server 44 can use machine learning to train an artificial intelligence engine to recognise and categorise domain names and keywords in order to mine dictionaries for keywords related to the initial keyword.

With a list of keywords identified against a domain name, the domain parking interface server 44 is in a position to start optimising a domain name. In the most basic sense, the optimisation algorithm implemented by the optimisation engine 46 makes a decision that amounts to activating a keyword for earning revenue. This decision is most effective when information pertaining to the candidate keyword list is as accurate and up to date as possible this leads to a basic model that focuses on discovering information about unknown keywords (learning). Examples of this model include the following:

(a) Basic Keyword Rotation—the behaviour of this simplistic optimisation model is to apportion a fixed and ongoing schedule of time devoted to both learning and earning revenue. For example, the optimisation engine 46 may learn on days 1 and 2, then select the best of those two keywords for earning revenue on day 3. Then the optimisation engine will again learn on day 4 and select the keyword for earning revenue on day 5, and then learn on day 6, earn revenue on day 7 and so on;

(b) Reactive KW Rotation—this model advances the basic keyword rotation model by using historical RPM data to try to ensure that the best known keyword is used the most. In this model, the optimisation engine 46 will score a keyword by applying more relevance on recent keyword statistics and less relevance to all the statistics of that keyword's performance;

(c) Corrective KW Rotation Version 1—this model advances the reactive KW rotation model by developing trends and applying probabilities to historical data to predict future RPM values and thus try to ensure that the best known keywords is used the most. Like other approaches, this approach is predictive however it attempts to incorporate knowledge of seasonal trends as evident in the historical data collected by the system;

(d) Corrective KW Rotation Version 2—this model advances the version 1 model by using external data sources, such as advertising data, to predict future RPM vales and select keywords for earning revenue accordingly.

Although this invention has been described in certain specific embodiments, those skilled in the art will have no difficulty devising variations to the described embodiment which in no way departs from the spirit and scope of the present invention. Thus, the present embodiments of the invention should be considered in all respects as illustrative and not restrictive, the scope of the invention being indicated by the appended claims.

What is claimed:

1. A computerised system for optimising domain parking pages, the system including:
one or more domain parking servers for populating domain parking pages with advertising links and serving the domain parking pages to users;
a database in communication with each domain parking server for maintaining domain name configuration data associating parked domain names with active keywords, wherein, upon receipt of an parked domain name, each domain parking server uses an associated active keyword to recover one or more advertising links to populate each domain parking page according to relevant domain name configuration data; and
a domain parking interface server, in communication with each domain parking server, for managing the domain name configuration data,
the domain parking interface server including:
an optimisation engine for automatically determining a series of actions to take upon the domain name configuration data in order to optimise user selection of the advertising links.

2. A computerised system according to claim 1, wherein the optimisation engine acts to:
score keywords in terms of their potential for optimising use selection of the advertising links; and
associate advertising links with keywords based upon those scores.

3. A computerised system according to claim 2, wherein the optimisation engine acts to score keywords from historically observed user selections of advertising links associated with each keyword.

4. A domain parking interface server forming part of a computerised system for optimising domain parking pages, the system including one or more domain parking servers for populating domain parking pages with advertising links to domain names and serving the domain parking pages to users; and a database in communication with each domain parking server for maintaining domain name configuration data associating parked domain names with active keywords, wherein, upon receipt of a parked domain name, each domain parking server uses an associated active keyword to recover one or more advertising links to populate each domain parking page according to relevant domain name configuration data,
wherein the domain parking interface server, in communication with each domain parking server, acts to manage the domain name configuration data, the domain parking interface server including:
an optimisation engine for automatically determining a series of actions to take upon the domain name configuration data in order to optimise user selection of the advertising links.

5. A method for optimising domain parking pages in a computerised system for optimising domain parking pages including one or more domain parking servers for populating domain parking pages with advertising links to domain names and serving the domain parking pages to users; a database in communication with each domain parking server for maintaining domain name configuration data associating parked domain names with active keywords, wherein, upon receipt of a parked domain name, each domain parking server uses an associated active keyword to recover one or more advertising links to populate each domain parking page according to relevant domain name configuration data; and a domain parking interface server, in communication with each domain parking server, for managing the domain name configuration data, the method including the step of:
automatically determining a series of actions to take upon the domain name configuration data in order to optimise user selection of the advertising links.

6. A computer program for use in a computerised system for optimising domain parking pages, the system including one or more domain parking servers for populating domain parking pages with advertising links to domain names and serving the domain parking pages to users; a database in communication with each domain parking server for maintaining domain name configuration data associating parked domain names with active keywords, wherein, upon receipt of a parked domain name, each domain parking server acts to select one or more advertising links to populate each domain parking page according to relevant domain name configuration data; and a domain parking interface server, in communication with each domain parking server, for managing the domain name configuration data, wherein the computer program includes a series of instructions for causing the domain parking interface server to:
automatically determine a series of actions to take upon the domain name configuration data in order to optimise user selection of the advertising links.
